(19) United States
(12) Patent Application Publication
(10) Pub. No.: US 2014/0187302 A1
(43) Pub. Date: Jul. 3, 2014

(54) Predictive Sports-Based Platforms

(71) Applicant: Jared Jeremy Ginsberg, Long Beach, NY (US)

(72) Inventor: Jared Jeremy Ginsberg, Long Beach, NY (US)

(21) Appl. No.: 14/157,850

(22) Filed: Jan. 17, 2014

Related U.S. Application Data
(63) Continuation-in-part of application No. 13/732,007, filed on Dec. 31, 2012.

(51) Int. Cl. A63F 13/00

(52) U.S. Cl. CPC A63F 13/005
USPC 463/9

(57) ABSTRACT

An apparatus for a contest based on the accuracy of predictions for a future sports event is described. Participants in a sports-based contests attempt to engage in multiple, successful predictions, which may result in “streaks” that provide for additional points or other rewards for contest participants. Participants may also engage in seed-based predictions, which may result in additional points or other rewards for contest participants.

### REFERENCE TO PRIOR APPLICATIONS

This application is a continuation-in-part of U.S. patent application Ser. No. 13/732,007, filed on Dec. 31, 2012.

### FIELD OF THE DISCLOSURE

The present disclosure relates generally to sports-related prediction and fantasy gaming apparatus and methods. More particularly, the disclosure relates to such specialized streak- and seed-based prediction techniques that may be used increase enjoyment of watching sporting activities. Also more particularly, the disclosure relates to such prediction techniques that may be used to benefit charities and other philanthropic organizations of interest to predictive sports-based contest sponsors, athletes, sports teams, sports leagues and their fans.

### BACKGROUND

Every sports event produces a large amount of analyzable data. Sports fans derive enjoyment from analyzing this data and predicting future events based on past performance of favorite athletes and their teams. And sports fans participate in games that simulate teams based on preset past data conditions to determine how changes in conditions might have altered the actual result. Such fans often participate in “fantasy” play or other simulation-related games to compete against other fans in their ability to predict future events. Taken together, these activities increase involvement and enjoyment of the sport for the fans, which in turn generates more revenue for the sports league, the sports teams and the athletes.

Fantasy play may include prediction of multiple events that may occur over several sessions. Putting together multiple, successful predictions may result in “streaks” that provide for additional points or other rewards for contest participants.

In addition, sports contest sponsors, sports leagues, sports teams and athletes are often associated with philanthropic organizations as a means to give to worthy causes. A sports contest sponsor, sports league, sports team or athlete often publicizes these associations as means to encourage others to give to these worthy causes and as a means to promote their involvement in the community at large. Fans that follow sports and participate in sports contests are often interested in all aspects of their favorite league, team or athlete and may desire to be informed about, and to participate in, such philanthropic activities that are associated with that contest, league, team or athlete.

Accordingly, there is a need for a method and apparatus for participants that use sports-related data for gaming, predicting or fantasy play. This may be associated with attempting to obtain streaks of correct predictions to enhance enjoyment of the experience. This may also be associated with philanthropic organizations of interest to sports contests, sports leagues, sports teams or athletes.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flowchart of a sports-related contest in accordance with some embodiments.

FIG. 2 is a flowchart of a sports-related contest with a charity tie-in in accordance with some embodiments.

FIG. 3 is a flowchart of a sports-related contest involving seed-based predictions with a charity tie-in in accordance with some embodiments.

FIG. 4 is a schematic illustrating the use of a single-elimination tournament to track seed-based predictions in accordance with some embodiments.

### DETAILED DESCRIPTION

As set forth in further detail, described herein are embodiments for participants that use sports-related data for gaming, predicting or fantasy play. Such play may include streaks of successful predictions or unique seed-based sequential predictions. Such play may also include association with philanthropic organizations of interest to sports contests, sports leagues, sports teams or athletes and their fans.

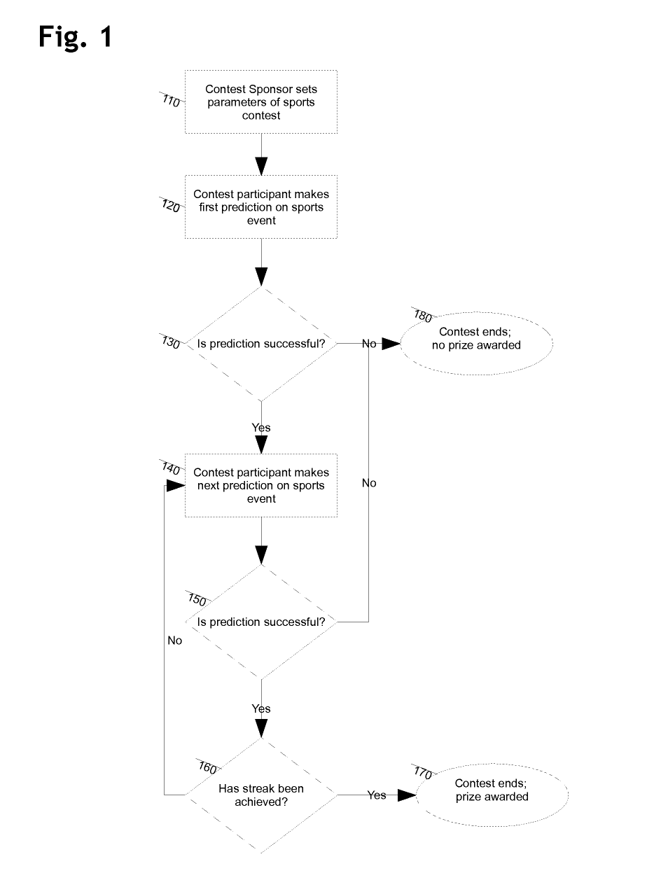

FIG. 1 is a block diagram showing an exemplary predictive sports-based platform. A contest sponsor sets up a sports-based contest for fans to enter (using paper or electronic format) 110. The contest sponsor sets parameters for contest entrants to predict sports-related events that will occur on a game-by-game, event-by-event or statistic-by-statistic basis. Such contests may be provided on a no-fee basis or the contest sponsor may collect a fee from the contest entrant for participation.

As an exemplary basis for the scheme, a contest entrant makes a prediction regarding a predetermined game, event or statistic 120. The prediction is then compared against the actual event 130. For those contest entrants who are incorrect, the contest ends 180. Those that correctly predict the first game, event or statistic are then eligible to proceed to the next round where the contest entrant must predict another game, event or statistic 140, which could be the same or different in kind from the first round.

The second prediction is then compared against the actual event 150. For those contest entrants who are incorrect, the contest ends 180. For those content participants who are correct, a determination is made whether the “streak” of successful predictions is long enough to win the contest 160. If the “streak” is long enough, the participant wins the contest and wins a prize 170. If the “streak” is not long enough, the process then repeats 140.

The examples of statistics that can be used for contest events and “streak” building are numerous. For U.S. football, it may be rushing yards, passing yards, receiving yards, passing touchdowns, rushing touchdowns, receiving touchdowns, sacks or interceptions of a particular player or team during one game or a series of games. For U.S. baseball, it may be steals and runs for position players and wins and saves for pitchers. For U.S. basketball, it may be points scored, rebounds or achieving “double-doubles” (in which a player accumulates a double-digit number total in two of five statistical categories—points, rebounds, assists, steals, and blocked shots—in a game). For U.S. hockey, it may be goals, saves or some combination of the above. Other sports offer similar opportunities for developing “streaks.”

The contest sponsor may provide for prizes for contest entrants based on the length of the “streak.” The contest sponsor may publicize the existence of developing “streaks” and successful “streaks” to promote the contest and to give other fans, sports leagues, sports teams and athletes a rooting interest in the outcome of the next round. Such promotion may include the use of advertisements, promotions and social media. The contest sponsor may initiate multiple overlapping prediction events in order to provide additional interest in the overall contest. The contest sponsor may provide that a contest entrant cannot base more than one round's prediction on the same athlete or event within a contest. The contest sponsor may also hedge against the risk of payouts that would be excessive to the sponsor by purchasing insurance that would provide the necessary prize money to be paid in the unlikely event that a contest entrant receives a large prize based on a very long successful “streak.”

In addition to providing the capability for members of the public to participate in contests that are open to all (which may be called “public leagues”), the contest sponsor may also choose to provide the infrastructure for contest entrants to set up contests of their own (which may be called “private leagues”). Under this infrastructure, one or more contest entrants may determine who may be admitted to a private league. The contest sponsor may arrange for the public leagues and private leagues to engage in multiple overlapping prediction events in order to provide additional interest in the overall contest.

A specialized streak system may also be set up by a contest sponsor to predict specific events in a sporting match. The streak-based predictions may include points awarded for particular events in a specific game. Points may be carried forward for additional correct predictions over a portion of a season or an entire season. Entrance into the contest may be paid or unpaid; those who succeed in the contest may or may not win cash or other prizes.

### Example

### NFL Regular Season Predictions

As an example, a multi-level prediction streak-based system may be based on the NFL football season. The NFL regular season presently consists of 17 weeks where games are generally played from Thursday to the following Monday. Contest entrants make predictions on a week-to-week basis for specific events that may happen in the coming week.

One such system may be a nine-category monthly prize competition and season prize competition. In each week, the entrant makes several predictions for each of one or more NFL games in that week. For example:

a. Passing Touchdowns—at least two touchdown passes thrown by a quarterback.

b. Passing Yards—at least 300 passing yards thrown by a quarterback.

c. Rushing Touchdowns—at least one rushing touchdown scored by a running back.

d. Rushing Yards—at least 100 rushing yards by a running back.

e. Receiving Touchdowns—at least 1 touchdown pass received by a wide receiver, tight end or running back.

f. Receiving Yards—at least 100 passing yards received by a wide receiver, tight end or running back.

g. Sacks—at least one whole quarterback sack recorded by a defensive player.

h. Interceptions—at least one pass intercepted by a defensive player.

i. Field Goals—at least two field goals kicked successfully.

If for any football week make nine accurate predictions are made, a bonus of three extra points is awarded for having made a perfect set of predictions for the week. Prizes may be awarded for the best scores in a particular portion of a season (such as a month) or for the whole season.

Another such system may be a two-category monthly prize competition and season prize competition. In each week, the entrant makes several predictions for each of one or more NFL games in that week. For example:

A. Passing Touchdowns and Rushing Touchdowns.

1. At least three touchdown passes thrown by a quarterback. Correct prediction receives one point.

2. At least one rushing touchdown scored by a running back. Correct prediction receives one point.

If both predictions are correct, the participant receives three extra points as a bonus.

B. Passing Touchdowns and Receiving Touchdowns.

1. At least three touchdown passes thrown by a quarterback. Correct prediction receives one point.

2. At least 1 touchdown pass received by a wide receiver, tight end or running back. Correct prediction receives one point.

If both predictions are correct, the participant receives three extra points as a bonus.

C. Rushing Touchdowns and Receiving Touchdowns.

1. At least one rushing touchdown scored by a running back. Correct prediction receives one point.

2. At least 1 touchdown pass received by a wide receiver, tight end or running back. Correct prediction receives one point.

If both predictions are correct, the participant receives three extra points as a bonus.

D. Passing Yards and Rushing Yards.

1. At least 300 passing yards by a quarterback. Correct prediction receives one point.

2. At least 100 rushing yards by a running back. Correct prediction receives one point.

If both predictions are correct, the participant receives three extra points as a bonus.

E. Passing Yards and Receiving Yards.

1. At least 300 passing yards thrown by a quarterback. Correct prediction receives one point.

2. At least 100 passing yards received—by a wide receiver, tight end or running back. Correct prediction receives one point.

If both predictions are correct, the participant receives three extra points as a bonus.

F. Rushing Yards and Receiving Yards.

1. At least 100 rushing yards by a running back. Correct prediction receives one point.

2. At least 100 passing yards received by a wide receiver, tight end or running back. Correct prediction receives one point.

If both predictions are correct, the participant receives three extra points as a bonus.

G. Passing Touchdowns and Passing Yards.

1. At least three touchdown passes thrown by a quarterback. Correct prediction receives one point.

2. At least 300 passing yards thrown by a quarterback. Correct prediction receives one point.

At least 300 passing yards thrown by a quarterback. Correct prediction receives one point.

H. Rushing Touchdowns and Rushing Yards.

1. At least one rushing touchdown scored by a running back. Correct prediction receives one point.

2. At least 100 rushing yards by a running back. Correct prediction receives one point.

If both predictions are correct, the participant receives three extra points as a bonus.

I. Receiving Touchdowns and Receiving Yards.

1. At least 1 touchdown pass received by a wide receiver, tight end or running back. Correct prediction receives one point.

2. At least 100 passing yards received by a wide receiver, tight end or running back. Correct prediction receives one point.

If both predictions are correct, the participant receives three extra points as a bonus.

Prizes may be awarded for the best scores in a particular portion of a season (such as a month) or for the whole season.

Another such system may be a three-category grand prize competition for an entire NFL regular season. For example, separate Grand Prizes may be offered, one each, for three categories of correct Predictions of real-world player performance:

(1) Touchdowns (Passing, Receiving and Rushing),

(2) Yards (Passing, Receiving and Rushing) and

(3) Defense/Special Teams (Sacks, Interceptions and Field Goals).

To win any one of these, the entrant must make perfect in-category predictions each week, for all seventeen weeks of the NFL season. The following shows the real-world player performance that may be needed for the predictions:

TOUCHDOWNS

a. Passing Touchdowns—at least two touchdown passes thrown by a quarterback.

b. Rushing Touchdowns—at least one rushing touchdown scored by a running back.

c. Receiving Touchdowns—at least 1 touchdown pass received by a wide receiver, tight end or running back.

YARDS

a. Passing Yards—at least 300 passing yards by a quarterback.

b. Rushing Yards—at least 100 rushing yards by a running back

c. Receiving Yards—at least 100 passing yards received by a wide receiver, tight end or running back.

DEFENSE AND SPECIAL TEAMS

a. Sacks—at least one whole quarterback sack recorded by a defensive player.

b. Interceptions—at least one pass intercepted by a defensive player.

c. Field Goals—at least two field goals kicked successfully.

The winner (if any) of a grand prize will be the participant who has achieved an unbroken “streak” of three correct predictions of one of the three grand prize prediction categories (namely, (1) Touchdowns, (2) Yards, and (3) Defense and Special Teams) for each of the seventeen weeks of the season. (In case of ties, the grand prize will be divided evenly per capita among all grand prize winners. If no participant achieves an unbroken streak, the grand prize will not be awarded.

Resolving Ties

Ties in a contest may be decided by the following criteria.

In case of ties in the Nine-Category monthly competitions and in the Nine-Category season competition, the winner among all tying eligible participants in the applicable competition will be selected by progressive reference to individual performance categories, as follows.

1. Most touchdown passes thrown by a quarterback. The tying participant with the highest total number of passing touchdowns accumulated by quarterbacks that the participant selected throughout the competition period, without regard to any bonus points awarded, will win the tie.

2. Most rushing touchdowns by a running back. If reference to most touchdown passes by a quarterback does not resolve the tie, then the winner among all tying participants who remain tied will be the tying participant with the highest total number of rushing touchdowns by running backs that the participant selected throughout the competition period, without regard to any bonus points awarded.

3. Most touchdown passes received by a wide receiver, tight end, or running back. If reference to most rushing touchdowns by a running back does not resolve the tie, then the winner among all tying participants who remain tied will be the tying participant with the highest total number of receiving touchdowns by wide receivers, tight ends or running backs that the participant selected throughout the competition period, without regard to any bonus points awarded.

4. Most passing yards by a quarterback. If reference to most touchdown passes received by wide receivers, tight ends or running backs does not resolve the tie, then the winner among all tying participants who remain tied after that reference will be the tying participant with the highest total number of passing yards by quarterbacks that the participant selected throughout the competition period, without regard to any bonus points awarded.

5. Most rushing yards by a running back. If reference to most passing yards by quarterbacks does not resolve the tie, then the winner among all tying participants who remain tied will be the tying participant with the highest total number of rushing yards by running backs that the participant selected throughout the competition period, without regard to any bonus points awarded.

6. Most passing yards received by a wide receiver, tight end or running back. If reference to the highest total number of rushing yards by running backs does not resolve the tie, then the winner among all tying participants who remain tied will be the participant with the highest total number of receiving yards by wide receivers, tight ends or running backs that the participant selected throughout the competition period, without regard to any bonus points awarded.

7. Most quarterback sacks recorded by a defensive player. If reference to most receiving yards received by wide receivers, tight ends or running backs does not resolve the tie, then the winner among all tying participants who remain tied will be participant with the most quarterback sacks recorded by defensive players that the participant selected throughout the competition period, without regard to any bonus points awarded.

8. Most passes intercepted by a defensive player. If reference to most quarterback sacks recorded by defensive players does not resolve the tie, then the winner among all tying participants who remain tied will be the participant with the most passes intercepted by defensive players that the participant selected throughout the competition period, without regard to any bonus points awarded.

9. Most field goals kicked successfully. If reference to most passes intercepted does by defensive players does not resolve the tie, then the winner among all participants who remain tied will be the participant with the most field goals kicked successfully by defensive players that the participant selected throughout the competition period, without regard to any bonus points awarded.

10. For those remaining tied after application of all categories. If, after the sequential application of all of the discrete categories, any tie remains, then the applicable prize will be divided per capita among all participants who remain tied.

In case of a tie in any of the Two-Category season competitions, the winner among all tying eligible participants in the applicable competition will be selected by progressive reference to individual performance categories, as follows.

A. Passing touchdowns and rushing touchdowns.

1. The tying participant with the highest total number of passing touchdowns accumulated by quarterbacks that the participant selected throughout the season and the highest total number of rushing touchdowns accumulated by running backs that the participant selected throughout the season, combined, without regard to any bonus points awarded, will win the tie.

2. If reference to the highest total number of passing touchdowns accumulated by quarterbacks that the participant selected throughout the season and the highest total number of rushing touchdowns accumulated by running backs that the participant selected throughout the season, combined, does not resolve the tie, then the participant among all tying participants who remain tied, with the highest total number of passing touchdowns by quarterbacks that the participant selected throughout the season, without regard to any bonus points awarded, will win the tie.

3. If reference to the highest total number of passing touchdowns by quarterbacks that the participant selected throughout the season does not resolve the tie, then the participant among all tying participants who remain tied, with the highest total number of rushing touchdowns by running backs that the participant selected throughout the season, without regard to any bonus points awarded, will win the tie.

B. Passing touchdowns and receiving touchdowns.

1. The tying participant with the highest total number of passing touchdowns by quarterbacks that the participant selected throughout the season and the highest total number of receiving touchdowns by wide receivers, tight ends or running backs that the participant selected throughout the season, combined, without regard to any bonus points awarded, will win the tie.

2. If reference to the highest total number of passing touchdowns by quarterbacks that the participant selected throughout the season and the highest total number of receiving touchdowns by wide receivers, tight ends or running backs that the participant selected throughout the season, combined, does not resolve the tie, then the participant among all tying participants who remain tied, with the highest total number of passing touchdowns by quarterbacks that the participant selected throughout the season, without regard to any bonus points awarded, will win the tie.

3. If reference to the highest total number of passing touchdowns by quarterbacks that the participant selected throughout the season does not resolve the tie, then the participant among all tying participants who remain tied, with the highest total number of receiving touchdowns by wide receivers, tight ends or running backs that the participant selected throughout the season, without regard to any bonus points awarded, will win the tie.

C. Rushing touchdowns and receiving touchdowns.

1. The tying participant with the highest total number of rushing touchdowns by a running back and the highest total number of receiving touchdowns by wide receivers, tight ends or running backs that the participant selected throughout the season, combined, without regard to any bonus points awarded, will win the tie.

2. If reference to the highest total number of rushing touchdowns by running backs that the participant selected throughout the season and the highest total number of receiving touchdowns by wide receivers, tight ends or running backs that the participant selected throughout the season, combined, does not resolve the tie, then the participant among all tying participants who remain tied, with the highest total number of rushing touchdowns by running backs that the participant selected throughout the season, without regard to any bonus points awarded, will win the tie.

3. If reference to the highest total number of rushing touchdowns by running backs that the participant selected throughout the season does not resolve the tie, then the participant among all tying participants who remain tied, with the highest total number of receiving touchdowns by wide receivers, tight ends or running backs that the participant selected throughout the season, without regard to any bonus points awarded, will win the tie.

D. Passing yards and rushing yards.

1. The tying participant with the highest total number of passing yards by a quarterback that the participant selected throughout the season and the highest total number of rushing yards by a running back that the participant selected throughout the season, combined, without regard to any bonus points awarded, will win the tie.

2. If reference to the highest total number of passing yards by quarterbacks that the participant selected throughout the season and rushing yards by running backs that the participant selected throughout the season, combined, does not resolve the tie, then the participant among all tying participants who remain tied, with the highest total number of passing yards by quarterbacks that the participant selected throughout the season, without regard to any bonus points awarded, will win the tie.

3. If reference to the highest total number of passing yards by quarterbacks that the participant selected throughout the season, does not resolve the tie, then the participant among all tying participants who remain tied, with the highest total number of rushing yards by running backs that the participant selected throughout the season, without regard to any bonus points awarded, will win the tie.

E. Passing yards and receiving yards.

1. The tying participant with the highest total number of passing yards by quarterbacks that the participant selected throughout the season and the highest total number of receiving yards by wide receivers, tight ends or running backs that the participant selected throughout the season, combined, without regard to any bonus points awarded, will win the tie.

2. If reference to the highest total number of passing yards by quarterbacks that the participant selected throughout the season and the highest total number of receiving yards by wide receivers, tight ends or running backs that the participant selected throughout the season, combined, does not resolve the tie, then the participant among all tying participants who remain tied, with the highest total number of passing yards by quarterbacks that the participant selected throughout the season, without regard to any bonus points awarded, will win the tie.

3. If reference to the highest total number of passing yards by quarterbacks that the participant selected throughout the season, does not resolve the tie, then the participant among all tying participants who remain tied, with the highest total number of receiving yards by wide receivers, tight ends or running backs that the participant selected throughout the season, without regard to any bonus points awarded, will win the tie.

F. Rushing yards and receiving yards.

1. The tying participant with the highest total number of rushing yards by running backs that the participant selected throughout the season and the highest total number of receiving yards by wide receivers, tight ends or running backs that the participant selected throughout the season, combined, without regard to any bonus points awarded, will win the tie.

2. If reference to the highest total number of rushing yards by a running back and the highest total number of receiving yards by wide receivers, tight ends or running backs that the participant selected throughout the season, combined, does not resolve the tie, then the participant among all tying participants who remain tied, with the highest total number of rushing yards by a running back, without regard to any bonus points awarded, will win the tie.

3. If reference to the highest total number of rushing yards by running backs that the participant selected throughout the season, does not resolve the tie, then the participant among all tying participants who remain tied, with the highest total number of receiving yards by wide receivers, tight ends or running backs that the participant selected throughout the season, without regard to any bonus points awarded, will win the tie.

G. Passing touchdowns and passing yards.

1. The tying participant with the highest total number of passing touchdowns by quarterbacks that the participant selected throughout the season and the highest total number of passing yards by quarterbacks that the participant selected throughout the season, combined, without regard to any bonus points awarded, will win the tie.

2. If reference to the highest total number of passing touchdowns by quarterbacks that the participant selected throughout the season and the highest total number of passing yards by quarterbacks that the participant selected throughout the season, combined, does not resolve the tie, then the participant among all tying participants who remain tied, with the highest total number of passing touchdowns by quarterbacks that the participant selected throughout the season, without regard to any bonus points awarded, will win the tie.

3. If reference to the highest total number of passing touchdowns by quarterbacks that the participant selected throughout the season, does not resolve the tie, then the participant among all tying participants who remain tied, with the highest total number of passing yards by quarterbacks that the participant selected throughout the season, without regard to any bonus points awarded, will win the tie.

H. Rushing touchdowns and rushing yards.

1. The tying participant with the highest total number of rushing touchdowns by running backs that the participant selected throughout the season and the highest total number of rushing yards by running backs that the participant selected throughout the season, combined, without regard to any bonus points awarded, will win the tie.

2. If reference to the highest total number of rushing touchdowns by running backs that the participant selected throughout the season and the highest total number of rushing yards by running backs that the participant selected throughout the season, combined, does not resolve the tie, then the participant among all tying participants who remain tied, with the highest total number of rushing touchdowns by running backs that the participant selected throughout the season, without regard to any bonus points awarded, will win the tie.

3. If reference to the highest total number of rushing touchdowns by running backs that the participant selected throughout the season, does not resolve the tie, then the participant among all tying participants who remain tied, with the highest total number of rushing yards by running backs that the participant selected throughout the season, without regard to any bonus points awarded, will win the tie.

I. Receiving touchdowns and receiving yards.

1. The tying participant with the highest total number of receiving touchdowns by wide receivers, tight ends or running backs that the participant selected throughout the season and the highest total number of receiving yards by wide receivers, tight ends or running backs that the participant selected throughout the season, combined, without regard to any bonus points awarded, will win the tie.

2. If reference to the highest total number of receiving touchdowns by wide receivers, tight ends or running backs that the participant selected throughout the season and the highest total number of receiving yards by wide receivers, tight ends or running backs that the participant selected throughout the season, combined, does not resolve the tie, then the participant among all tying participants who remain tied, with the highest total number of receiving touchdowns by wide receivers, tight ends or running backs that the participant selected throughout the season, without regard to any bonus points awarded, will win the tie.

3. If reference to the highest total number of receiving touchdowns by wide receivers, tight ends or running backs that the participant selected throughout the season, does not resolve the tie, then the participant among all tying participants who remain tied, with the highest total number of receiving yards by wide receivers, tight ends or running backs that the participant selected throughout the season, without regard to any bonus points awarded, will win the tie.

If, after the sequential application of all of the discrete categories, any tie remains, then the applicable prize will be divided per capita among all participants who remain tied.

Additional Point-Based and Streak-Based Contests

The concepts discussed above may be applied to a multitude of sports-based prediction contests using various sports and grouping of statistics within those sports. Scoring for the predictions may be awarded for contest entrants that correctly predict individual achievements of a particular athlete or team (point-based predictions) or for a series of correct predictions of individual achievements of a particular athlete or team with no intervening incorrect predictions (streak-based predictions). Point-based scoring may be tallied at the end of each round of play (which, depending on the sport, may be daily or weekly), at the end of each month, at the end of a half-season or the end of a full season.

Generally, point-based prediction games may require a fee to enter and streak-based prediction games may not require a fee to enter.

Also generally, the prizes for streak-based prediction games will be higher and may require the use of insurance purchase the sponsor to cover the rarer and larger prizes won by the entrant that correctly predicts the streak.

As further examples, there may be the following prediction contests:

3 Statistic Competitions (streak based and/or point based):

For baseball:
Hits/Runs/Steals

For example, the contest entrant would determine for a particular upcoming baseball game whether a player will obtain a predetermined number of hits, runs and steals for that game. If correct, points are awarded and/or streaks are built.
Hits/Homeruns/Steals
Wins/Strikeouts/Saves

For hockey:
Goals/Assists/Saves

For basketball:
Points/Assists/Rebounds
Points/Assists/Steals
Points/Assists/Blocks

For football:
Passing TDs/Rushing TDs/Receiving TDs
Passing Yards/Rushing Yards/Receiving Yards
Field Goals/Sacks/Interceptions

For soccer
Goals/Assists/Saves

2 Stat Competitions (streak based and/or point based):

For baseball
Hits/Runs
Hits/Steals
Homeruns/Runs
Wins/Strikeouts
Wins/Saves
Saves/Strikeouts

For football:
Passing TDs/Rushing TDs
Passing TDs/Receiving TDs
Rushing TDs/Receiving TDs
Passing Yards/Rushing Yards
Passing Yards/Receiving Yards
Rushing Yards/Receiving Yards
Passing TDs/Passing Yards
Rushing TDs/Rushing Yards
Receiving TDs/Receiving Yards

For hockey:
Goals/Assists
Goals/Saves

For basketball:
Points/Assists
Points/Rebounds
Assists/Rebounds
Points/Blocks
Assists/Steals

For soccer:
Goals/Assists

Cumulative Scoring (Generally Point Based)

Basketball:
Points/Assists/Rebounds/Blocks/Steals/3 Pointers

In this prediction-based contest, the entrant may predict whether a certain player or players will obtain a preset number of achievements in various statistics in the same game. For example, an entrant may make predictions whether a player will achieve 20 or more points, 10 or more assists, 5 or more rebounds, 3 or more blocks, 3 or more steals or 2 or more 3-pointers.

For hockey:
Goals/Assists/Saves

For football:
Passing TDs/Rushing TDs/Receiving TDs/Passing Yards/Rushing Yards/Receiving Yards/Field Goals/Sacks/Interceptions

For soccer:
Goals/Assists/Saves

For baseball:
Hits/Runs/Steals/Homeruns/Wins/Strikeouts/Saves

Additional Statistics for Football

The foregoing contests and games may be applied to many football statistics including the following:

Games Played—G

The number of games a player has participated in. A player must participate in at least one offensive, defensive or special teams play.

Total Yards (Yds)

The total number of offensive yards that a player gained.

Total Points (Pts)

The total points scored by a player on offense.

Penalties (Pen)

The number of penalties accepted against a player on offense.

Penalty Yards (Pen Yds)

The amount of penalty yards that have been accepted against a player on offense.

Passing Attempts (Att)

The number of passing attempts a player makes. The attempts could result in a reception, incompletion or interception.

Passing Completions (Comp)

The number of passes that a player successfully completes and is caught by a receiver.

Passing Completion Percentage (Pct)

The percentage of pass attempt that are successfully completed. This is calculated by dividing the number of completions by the number of passing attempts.

Passing Yards (Yds)

The total number of yards gained by successful pass completions. This includes both the passing yards and the yards gained after the reception.

Yards per Game (YPG)

The average number of passing yards a player successfully completes per game played. This is calculated by dividing the number of yards gained through successful pass completions by the number of games played by the player.

Yards per Attempt (YPA)

The average number of passing yards a player successfully completes per passing attempt. This is calculated by dividing the number of yards gained through successful pass completions by the number of games played by the player.

Passer Rating (Rating)

This is a large formula used to calculate a passer's performance. This is the formula used by the NFL to calculate a passer's Rating. It is calculated using the following formula:

(((Comp/Att*100−30)/20)+((Yds/Att−3)/4)+(TD*20/Att)+(2.375−(Int*25/Att))*50/3

Passer Efficiency (Eff)

This is a large formula used to calculate a passer's performance. This is the formula used by the NCAA and is calculated using the following formula:

(Comp*100/Att)+(Yds*8.4/Att)+(TD*330/Att)−(Int*200/Att)

Touchdowns (TD)

The number of touchdowns scored through a player's successful pass completion.

Interceptions (Int)

The number of interceptions a pass has thrown. An interception is when a pass is successfully caught by an opposing player.

Sacks (Sck)

The number of times a player is sacked while attempting a pass. A sack is when a player is tackled behind the line of scrimmage while attempting a pass.

Yards Lost (YL)

The number of yards lost through sacks.

Longest Pass Play (Long)

The longest gain from a successful pass completion made by a player.

First Down Passes (FD)

The number of times a player successfully completes a pass and the play results in a first down.

PAT Conversion Points (PAT)

The number of Point After Touchdown (PAT) points obtained by a successful completion.

Attempts (Att)

The number of rushing attempts a player has made.

Yards (Yds)

The total number of rushing yards gained by a player.

Yards Per Game (YPG)

The average number of rushing yards gained per game played. This is calculated by dividing the number of rushing yards by the number of games played.

Yards Per Attempt (YPA)

The average number of rushing yards gained per rushing attempt. This is calculated by dividing the number of rushing yards by the number of rushing attempts made.

Touchdowns (TD)

The number of rushing touchdowns scored by a player.

Longest Rush (Long)

The longest rushing play gained by a player.

First Downs (FD)

The number of first downs gained by a rusher.

PAT Conversion Points (PAT)

The number of Point After Touchdown (PAT) points score by a rusher.

Fumbles (Fum)

The number of fumbles by a player. This counts both fumbles that were recovered by the player's team or the opposing team.

Fumbles Lost (Lost)

The number of fumbles committed by a player that are recovered by the opposing team.

Attempts (Att)

The number of passes that are thrown to a receiver. This counts passes that are completed and passes that are incomplete.

Receptions (Rec)

The number of passes successfully caught by a receiver.

Yards (Yds)

The number of yards gained by a receiver of a successful pass completion. This includes the yards from the pass and the yards gained after the reception.

Yards Per Catch (YPC)

The average number of yards gained by a receiver per catch made. This is calculated by dividing receiving yards by receptions.

Yards Per Game (YPG)

The average number of yards gained by a receiver per game played. This is calculated by dividing receiving yards by games played.

Longest Reception (Long)

The longs reception gained by a player.

Yards After Catch (YAC)

The number of yards gained by a receiver after making a reception.

Touchdowns (TD)

The number of touchdowns scored by a receiver.

Drops (Drops)

The number of passes thrown to a receiver that are dropped.

First Down Receptions (FD)

The number of receptions by a player that resulted in a first down.

PAT Conversion Points (PAT)

The number of points scored through receptions on Point After Touchdown (PAT) plays.

Solo Tackles (Solo)

The number of unassisted tackles made by a defensive player.

Assist Tackles (Ast)

The number of assisted tackles made by a defensive player.

Tackles (Tkl)

The total number of tackles made by a player. Calculated by adding the solo and assisted tackles.

Sacks (Sack)

The number of sacks made by a defensive player. A sack is when a defensive player tackles the opposing quarterback behind the line of scrimmage while the quarterback is attempting a pass. Sacks are counted as a full sack when it is unassisted and a half sack when the sack is assisted by another player.

Tackle for Loss (TFL)

The number of tackles made by a defensive player behind the line of scrimmage which results in a loss for the opposing team.

Interceptions (Int)

The number of times a defender successfully catches a pass from an opposing passer.

Interception Yards (Int Yds)

The total number of yards gained by a defender after making an interception.

Interception TD (Int TD)

The number of touchdowns scored by a defender after making an interception.

Forced Fumble (FF)

The number of fumbles that are forced by a defender.

Fumble Recovery (FR)

The number of fumbles successfully recovered by a defender.

Fumble Recovery Yards (FRY)

The number of yards gained by a defender after successfully recovering a fumble.

Fumble Recovery TD (FRTD)

The number of touchdowns scored by a defender after successfully recovering a fumble.

Penalties (Pen)

The number of penalties accepted against a player on defense.

Penalty Yards (Pen Yds)

The amount of penalty yards that have been accepted against a player on defense.

Kick Returns (KR)

The number of kick-offs that a player received and had a chance to return.

KR Yards (KR Yds)

The number of yards gained by a player during kick returns.

KR Avg Yards (KR Avg)

The average number of yards gained per kick return. Calculated by the total number of yards gained during kick returns divided by the number of kick returns.

KR Longest (KR Long)

The longest kick-return play gained by a player.

Punt Returns (PR)

The number of punts received by a player.

PR Yards (PR Yds)

The number of yards gained from returning punts.

PR Avg Yards (PR Avg)

The average number of yards gained per punt return. Calculated by the total number of yards gained during punt returns divided by the number of punt returns.

PR Fair Catches (FC)

The number of fair catches called while receiving a punt.

PR Longest (PR Long)

The longest punt return played gained by a player.

Punts (Punts)

The number of punts kicked by a player.

Longest Punt (PuntLong)

The longest punt kicked by a player.

Punt Yards (Punt Yds)

The total number of yards kicked by punts.

Punt Inside 20 (<20)

The number of punts kicked by a player that landed or were caught inside of the opponents 20 yard line.

Avg Punt Yards (Punt Avg)

The average number of yards kicked during a punt. Calculated by dividing the number of punt yards by the number of punts kicked.

Penalties (Pen)

The number of penalties accepted against a player on special teams.

Penalty Yards (Pen Yds)

The amount of penalty yards that have been accepted against a player on special teams.

FG Blocked (FG Blk)

The number of kicks by an opponent that were blocked by a player.

Blocked Kicks (Blk)

The number of kicks a kicker attempted that were blocked by the opposing team.

Field Goal Attempts (FG Att)

The number of field goals attempted by a player.

Field Goals Made (FG)

The number of field goals successfully kicked by a player.

Field Goal Percentage (FG %)

The perchance of field goals kicked that are successful. This is calculated by dividing the number of field goals made by the number of field goals attempted.

Longest Field Goal (FG Long)

The longest field goal successfully kicked by a player.

PAT Attempts (PATAtt)

The number of Point After Touchdown (PAT) kick attempts a player attempts.

PAT Made (PAT)

The number of Point After Touchdown (PAT) kick attempts successfully kicked by a player.

The foregoing description may be applied to other sports or games. A contest may be arranged that require a number of correct predictions to achieve points with additional points awarded if all predicted events turn out to be correct.

Additional Statistics for Baseball

The foregoing contests and games may be applied to many baseball statistics, including:

Games Played—G

The number of games a player has participated in. A player has played in a game when they have met at least one of the following conditions: making a plate appearance, making a pitching appearance or being placed in the lineup as a defensive fielder.

Plate Appearances—PA

The number of times the player has appeared at the plate.

At Bats—AB

The number of official at bats the player has had. This is defined as the number of plate appearances minus sacrifice hits, walks, and when the batter was hit by a pitch

Walks—BB

The number of walks, or base on balls. It is achieved by taking four balls during an at bat.

Strikeouts—K

The number of strikeouts the batter has, either by taking a third strike, swinging and missing the third strike, or bunting foul for the third strike.

Hits—H

The number of times the batter hit the ball and safely reached base without error or fielder's choice. This is defined as the total number of the singles, doubles, triples and home runs.

Singles—1B

The number of times the batter hit the ball and safely reached first base without error or fielder's choice.

Doubles—2B

The number of times the batter hit the ball and safely reached second base without error or fielder's choice.

Triples—3B

The number of times the batter hit the ball and safely reached third base without error or fielder's choice.

Home Runs—HR

The number of times the batter hit the ball and safely reached home plate to score a run. This can be accomplished by hitting the ball out of the field of play in fair territory or by reaching home plate without the aid of fielder's error.

Runs—R

The number of times a player scored a run by safely reaching home plate.

Runs Batted In—RBI

The number of runs that the player caused to be scored by hitting the ball or drawing a base on balls. The player does not need to reach base safely to be credited for an RBI.

Hit By Pitch—HBP

The number of times the batter safely reached first base by being hit by a pitch.

Reached on Error—ROE

The number of times the batter safely reached base by fielder's error.

Fielder's Choice—FC

The number of times the batter safely reached base because a fielder chose to get another baserunner out.

Stolen Bases—SB

The number of times a player steals a base.

Caught Stealing—CS

The number of times a player is tagged out while attempting to steal a base or is tagged out while taking a lead from a base.

Left On Base

The number of times a player has been stranded on base when the half-inning ends. The player must successfully reach base, not cause an out and not score a run when the inning ends.

Sacrifice Hits—SAC

The number of times a batter bunts and does not safely reach base, but allows a baserunner to advance.

Ground Into Double Play—GIDP

The number of times a batter has grounded into a double play.

Times on Base—OB

The number of times a batter safely reached base by a hit, walk or hit by pitch. If the player reaches base by fielder error or a fielder's choice, it is not counted as a time on base.

Total Bases—TB

The total number of bases a player obtains by a hit. It is a weighted statistic—a batter gets 1 for a single, 2 for a double, 3 for a triple and 4 for a home run.

Extra Base Hits—XB

The total number of doubles, triples and home runs the player hits.

Batting Average—AVG

The average number of hits that the batter has. This is defined as the number of hits divided by the number of at bats.

On Base Percentage—OBP

The percentage of time that the batter reached base safely. This is the number of times on base (OB) divided by the number of at bats, walks, times hit by pitch.

Slugging Percentage—SLG

A weighted statistic to determine the amount of slugging power of a batter. It is the number of total base (TB) divided by the number of at bats (AB).

Stolen Base Percentage—SBP

The percentage of attempts that a base runner successfully steals a base. It is the number of stolen bases (SB) divided by the total attempts to steal a base (SB+CS).

On Base Percentage Plus Slugging—OPS

The summation of the On Base Percentage (OBP) and Slugging Percentage (SLG).

Appearances—App

The total number of games that pitcher has appeared in.

Innings Pitched—IP

The total number of innings that a pitcher has successfully completed. Fractional innings are expressed as 0.1 for 1 out and 0.2 for 2 outs. If a pitcher pitches in an inning, but does not retire a batter, the pitcher is not given credit for any innings pitched.

Batters Faced—BF

The total numbers of batters that a pitcher faced.

Runs Allowed—R

The total number of runs scored from batters that reached base while a pitcher was pitching. If a pitcher leaves the game in the middle of an inning while opposing players are on base, the pitcher is charged for each run that these baserunners score.

Earned Runs Allowed—ER

The total number of runs scored from batters that reached base without error while a pitcher was pitching. If a pitcher leaves the game in the middle of an inning while opposing players are on base, the pitcher is charged for each run that these baserunners score. If an error occurs to allow the runner to reach base, advance base or extend the inning, the run is not counted as earned for the pitcher.

Strikeouts—K

The number of batters that a pitcher strikes out by the batter taking or swinging and missing at a third strike in an at bat.

Walks—BB

The number of walks, or base on balls, that pitcher allows by pitching four balls in a plate appearance.

Singles Allowed—1B

The number of times the opposing batter safely reaches first base by hitting the ball and no error or fielder's choice occurs.

Doubles Allowed—2B

The number of times the opposing batter safely reaches second base by hitting the ball and no error or fielder's choice occurs.

Triples Allowed—3B

The number of times the opposing batter safely reaches third base by hitting the ball and no error or fielder's choice occurs.

Home Runs Allowed—HR

The number of times an opposing batter safely reaches home plate by hitting the ball without an error or fielder's choice. This can happen if the opposing batter hits the ball out of the field of play in fair territory or if the batter safely reaches home plate after hitting the ball.

Fly Balls—FB

The number of times a pitcher allows a batter to hit a fly ball.

Ground Balls—GB

The number of times a pitcher allows a batter to hit a ground ball.

Ground Ball/Fly Ball Ratio—G/F

The ratio of ground balls allowed to the number of fly balls allowed.

Batters Hit By Pitch—HBP

The number of opposing batters that a pitcher allows to reach base by hitting the batter with a pitch.

Balls

The number pitches thrown by a pitcher that are not in the strike zone and not swung at by the opposing batter.

Strikes

The number of pitches thrown by a pitcher that are in the strike zone and/or swung at by the opposing batter.

Wild Pitches—WP

The number of pitches thrown that cannot be fielded by a catcher and allows a baserunner to advance.

Balks—BK

The number of times a pitcher allows a baserunner to advance by performing an illegal move on the pitching mound.

Wins—W

The number of wins that are credited to a pitcher. A win is when the pitcher's team obtains the lead while the player is the active pitcher and the team does not give up the lead to win the game.

Losses—L

The number of losses that are credited to a pitcher. A loss is when the pitcher's team falls behind in score while player is the active pitcher, does not tie or take the lead and loses the game.

Saves—S

The number of times a pitcher “saves” the game by pitching in relief and not surrendering the lead.

Blown Saves—BS

The number of times a pitcher makes a relief appearances in a save situation, and gives up at least one run and allows the opponent or tie the game or take the lead.

Hold—HLD

The number of times a relief pitcher enters the game in a save situation, gets at least one out, does not surrender the lead, but did not finish pitching the game. The pitcher is credited for “holding” the lead.

Complete Games—CG

The number of times a pitcher throws every pitch for their team in a completed game.

Earned Run Average—ERA

The average number of earned runs in a game that the pitcher allows. It is the total number of earned runs allowed multiplied by the normal number of innings in a game (9 in Major League Baseball) and divided by the number of innings pitched.

Walks and Hits Per Inning Pitched—WHIP

The average number of walks and hits allowed per inning a pitcher has pitched. Calculated by taking the sum of hits and walks allowed and dividing by the number of innings pitched.

Games Played—G

The number of games a player has participated in. A player has played in a game when they have met at least one of the following conditions: making a plate appearance, making a pitching appearance or being placed in the lineup as a defensive fielder.

Innings Played—Inn

The total number of innings that a player is in the field. Fractional innings are expressed as 0.1 for 1 out and 0.2 for 2 outs.

Total Chances—TC

The total number of chances a player has to make a play. This is the total number of assists, put outs and errors.

Put Outs—PO

The total number of times a fielder causes a baserunner to be out.

Assists—A

The total number of times a fielder assists another player in obtaining a put out.

Double Plays—DP

The total number of double plays that a player is part of.

Errors—E

The number of fielding errors committed by a fielder.

Stolen Bases Allowed—SB

The total number of base runners that steal a base for a catcher.

Runners Caught Stealing—CS

The number of base runners that a catcher gets out while attempting to steal a base.

Passed Balls—PB

The number of fieldable pitches that a catcher misses and allows a base runner to advance.

Fielding Percentage—FLDP

The percentage of plays that a fielder successfully makes a play. This is the total chances minus the error divided by total chances ((TC-E)/TC)

Range Factor—Range

A calculated stat used to determine how far of a range that a fielder has. Calculated by taking the sum of putouts and assists multiplied by the number of innings per game divided by the number of innings played. ((PO+A)*[Innings per game])/Inn

Additional Statistics for Basketball

The foregoing contests and games may be applied to many basketball statistics, including:

Games Played—G

The number of games a player has participated in.

Games Started—GS

The number of games that a player is in the starting lineup.

Minutes Played—Min

The total number of minutes played.

Points—Pts

The total number of points scored by a player. Points are scored by 2 and 3 field goals and by free throws.

Field Goals—FG

The number of field goals a player successfully scores.

Field Goal Attempts—FGA

The number of attempted field goals made by a player.

2 Point Field Goals—2FG

The number of two point field goals a player successfully scores.

2 Point Field Goal Attempts—2FGA

The number of attempted two point field goals made by a player.

3 Point Field Goals—3FG

The number of three point field goals a player successfully scores.

3 Point Field Goal Attempts—3FGA

The number of attempted three point field goals made by a player.

Field Goal Percentage—FG %

The percentage of field goal attempts that are successful. Two and three point field goals are calculated in this stat. Calculated by dividing Field Goals by Field Goal Attempts (FG/FGA).

3 Points Field Goal Percentage—3FG %

The percentage of three point field goal attempts that are successful. Calculated by dividing 3 Point Field Goals by 3 Point Field Goal Attempts (3FG/3FGA)

Free Throws—FT

The number of free throws a player successfully scores.

Free Throw Attempts—FTA

The number of free throws attempted by a player.

Free Throw Attempt Percentage—FG %

The percentage of free throws that are successful. Calculated by dividing Free Throws by Free Throw Attempts (FT/FTA)

Offensive Rebounds—ORB

The number of rebounds a player obtains while on offense.

Defensive Rebounds—DRB

The number of rebounds a player obtains while on defense.

Rebounds—Reb

The total number of rebounds a player obtains. The sum of offensive and defensive rebounds (ORB+DRB).

Assists—Ast

The number of assists a player obtains. An assist is earned when a player makes the last past to another player, who then scores a field goal.

Steals—Stl

The number of times a player gains possession from the opposing team without causing a foul.

Blocks—Blk

The number of times a player blocks an opponent's shot without causing a foul.

Turnovers—TO

The number of times a player is faulted for allowing the opposing team to take possession.

Personal Fouls—PF

The number of personal fouls charged to a player. A personal foul is generally charged to a player when the player makes illegal contact with an opponent.

Technical Fouls—TF

The number of technical fouls charged to a player. A technical foul can be charged for several reasons and are generally for infractions not covered by personal fouls.

Points Per Game—PPG

The average number of points a player scores per game played. It is calculated by dividing Points by Games Played (Pts/G).

Rebounds Per Game—RPG

The average number of rebounds a player has per game played. It is calculated by dividing Total Rebounds by Games Played (Reb/G).

Assists Per Game—APG

The average number of assists a player has per game played. It is calculated by dividing Assists by Games Played (Ast/G).

Steals Per Game—SPG

The average number of steals a player has per game played. It is calculated by dividing Steals by Games Played (Stl/G).

Minutes Per Game—MPG

The average time played, in minutes, per game played. It is calculated by dividing Minutes Played by Games Played (Min/G).

Turnovers Per Games—TPG

The average number of turnovers a player commits per game played. It is calculated by dividing Turnovers by Games Played (TO/G).

Blocks Per Game—BPG

The average number of blocks a player has per game played. It is calculated by dividing Blocks by Games Played (Blk/G).

Assists to Turnover Ratio—A/TO

The ratio of assists to turnovers. This stat helps show how well a player creates scoring opportunities through passing. It is calculated by dividing Assists by Turnovers (Ast/TO)

Effective Field Goal Percentage—EFG %

Similar to Field Goal Percentage, except that 3 point field goals are counted for 50% more since they count for an extra points. This stat gives a better point-scoring potential of players who attempt a lot of three pointers. It is calculated by adding 2 point field goals to 150% of the number of 3 point field goals all divided by field goal attempts. ((2FG+(1.5*3FG))/FGA).

Additional Statistics for Hockey

The foregoing contests and games may be applied to many hockey statistics, including:

Team statistics
STK—winning or losing Streak
GP—Games played—Number of games the team has played
W—Wins—Games the team has won in regulation.
L—Losses—Games the team has lost in regulation
T—Ties—Games that have ended in a tie (Note: The NHL no longer uses ties. Instead games are determined by OT or SO).
OTL—Overtime losses—Games the team has lost in overtime (Note: Many leagues do not separate overtime losses and regulation losses, including all losses in the losses statistic)
SOL—Shootout losses—Games the team has lost in a shootout
PTS—Points—Team points, calculated from W, OTW, OTL, L, SOL and SOW. As 3 points for a W, 2 points for a OTW or SOW and 1 point for a OTL or SOL and zero for a L.
GF—Goals for—Number of goals the team has scored
GA—Goals against—Number of goals scored against the team

OTW” and “SOW”˜are victories either in over time or a shoot-out. Points awarded are different than a “W”

Individual statistics
GP—Games played—Number of games the player has set foot on the ice in
G—Goals—Total number of goals the player has scored
A—Assists—Number of goals the player has assisted in
PTS—Points—Scoring points, calculated as the sum of G and A
PIM—Penalties in minutes—Number of penalty minutes the player has been assessed. For statistical purposes, ten minutes are recorded for a game misconduct, gross misconduct, or match penalty.
PPG—Power play goals—Number of goals the player has scored while his team was on the power play
PPA—Power play assists—Number of goals the player has assisted in while his team was on the power play
SHG—Shorthanded goals—Number of goals the player has scored while his team was shorthanded
SHA—Shorthanded assists—Number of goals the player has assisted in while his team was shorthanded
GWG—Game-winning goals—Number of game-winning goals the player has scored (a goal is considered game winning when the team would win the game without scoring any more goals, for example, the third goal in a 5-2 win)
GTG—Game-tying goals—Number of game-tying (that is, the last goal scored in a tie game) goals the player has scored
ENG—Empty net goals—Number of goals scored on an empty net
+/− or P/M—Plus/minus—The number of team even strength or shorthanded goals for minus the number of team even strength or shorthanded goals against while the player is on the ice (see plus/minus)
TOI—Time on ice—Total time on ice
ATOI—Average time on ice—The average amount of time the player spent on the ice in the games he played (total time on ice divided by games played)

Some other terms that are used include hits, faceoff wins, faceoff win percentage, takeaways, giveaways, shots on goal (SOG).

Goaltender Statistics
GP, G, A—Same as player statistics.
GS—Games started—The number of games the goaltender has started
MIN—Total number of minutes the goaltender has been on the ice
GA—Goals against—Number of goals scored against the goaltender
GAA—Goals against average—Mean goals-per-60 minutes scored on the goaltender (see goals against average)
W—Wins—Games the goaltender has won
L—Losses—Games the goaltender has lost (A goaltender is credited with a win or loss when he is either on the ice when—or was pulled for an extra attacker immediately before—the game-winning goal was scored)
T—Ties—Games the goaltender has tied (a goaltender is credited with a tie when he was on the ice for—or was pulled for an extra attacker immediately before—the game-tying goal was scored. In the case of 0-0 ties, the starting goaltender is credited with the tie)
SOG—Total number of shots on goal the goaltender has faced
SV—Saves—Number of shots on goal the goaltender has saved
SVP, SV %, or PCT—Save percentage—Percentage of the total shots faced the goaltender has saved (see save percentage)
SO—Shutouts—Number of games where the goaltender had no goals against him and was the only goaltender from his team to play in the game
ENG—Empty net goals—Number of goals scored while the goaltender was off the ice for an extra attacker.

Additional Statistics for Soccer

The foregoing contests and games may be applied to many soccer statistics, including:

GP: Games Played

GS: Games Started

G: Goals

MIN: Minutes Played

A: Assists

SHT: Shots

SOG: Shots on Goal

FC: Fouls Committed

FS: Fouls Suffered

OPF: Offsides

Y: Yellow Cards

R: Red Cards

GF: Goals For

GA: Goals Against

SO: Shutouts

SV: Saves

CK: Corner Kicks

PKA: Penalty Kick Attempts

PKG: Penalty Kick Goals

PKS: Penalty Kick Saves

INSRANCE ANCE, MARKETING AND CHARITY TIE-IN

Regarding prizes, the contest promoter may choose to obtain prize indemnity insurance. This is indemnification insurance for a promotion in which the participants are offered the chance to win prizes. Instead of keeping cash reserves to cover large prizes, the promoter may pay a premium to an insurance company, which then reimburses the insured should a prize be given away.

The promoters may also provide marketing tie-ins for promotion at various parts of the contest. Marketing promotion codes may be provided that contest entrants enter when registering for a contest. This may allow contest entrants to provide credit for contest sponsors. The contest sponsors may be commercial or philanthropic.

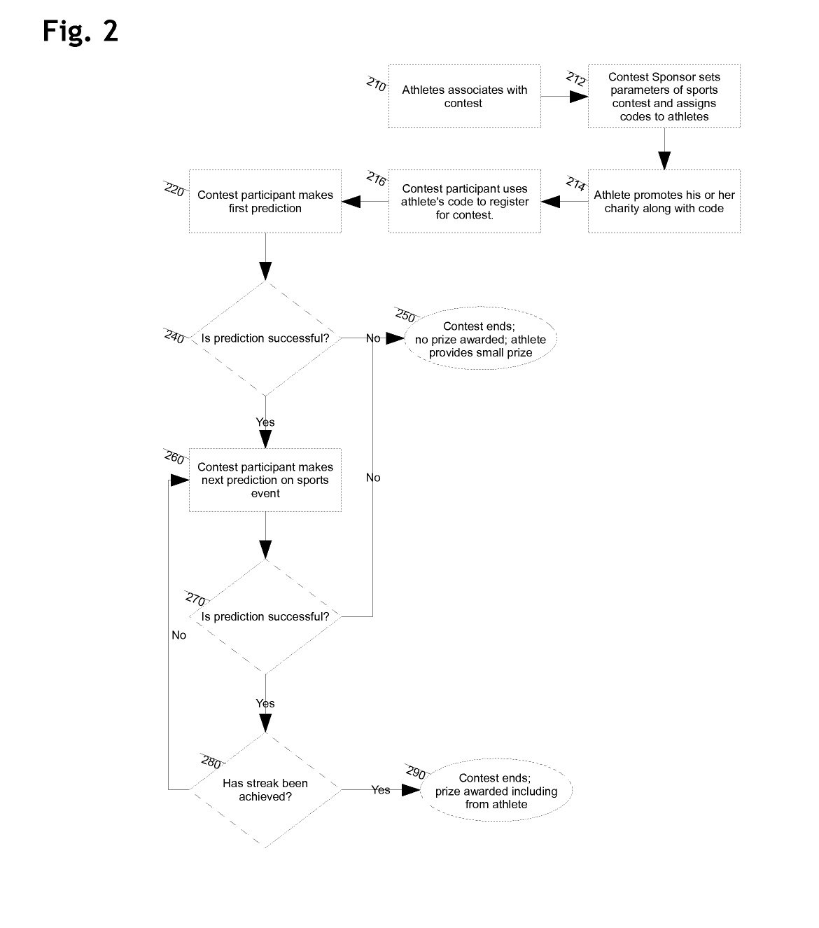

FIG. 2 demonstrates further feature of these sports-related contests with a charity tie-in. In addition to providing predictions based on sporting events, the contest sponsor may arrange for the contest entrant to associate his or her participation with one or more philanthropic organizations. These philanthropic organizations may be associated with the contest sponsor or contest entrant directly. In addition, the philanthropic organizations may be associated with (or sponsored by) the sports league, sports team and/or athletes that provide the underlying statistics for the contest. The contest sponsor may provide or make available an affinity code for contest entrants to use when entering the contest to identify the particular philanthropic organization that the contest entrant is interested in assisting. The contest sponsor may then donate part of the fee received from the contest entrant to the chosen philanthropic organization. In this way, those fans that identify with a contest sponsor, sports team, sports league or athlete may also identify with that entity's chosen philanthropic organization.

As an example, an athlete may associate with a contest sponsor engaged in a predictive contest 210. The contest sponsor then determines the parameters of the contest, including assigning the athlete a promotional code to provide to the athlete's fans when entering the contest 212. Once a code is established, the athlete may then encourage fans that follow that athlete to enter a particular contest 214. The athlete may publicize a promotional code to the fans that interested participants enter when joining the contest. When the participant enters the code while joining the contest, the contest sponsor associates that participation with the particular athlete 216.

A contest entrant makes a prediction regarding a predetermined game, event or statistic 220. The prediction may or may not be related to the performance of the sponsoring athlete, sports team or sports league. The prediction is then compared against the actual event 240. For those contest entrants who are incorrect, the contest ends 250. Those that correctly predict the first game, event or statistic are then eligible to proceed to the next round where the contest entrant must predict another game, event or statistic 260, which could be the same or different in kind from the first round.

The second prediction is then compared against the actual event 270. For those contest entrants who are incorrect, the contest ends 250. For those content participants who are correct, a determination is made whether the “streak” of successful predictions is long enough to win the contest 280. If the “streak” is long enough, the participant wins the contest and wins a prize 290. If the “streak” is not long enough, the process then repeats 260.

By using this technique, the contest sponsor, sports team, sports league or athlete with an interest in a specific charity or foundation may promote its interest via the contest by social media or other means. The contest sponsor may remit a percentage of fees collected from the contest entrants to the philanthropic organizations affiliated with contest sponsor itself, sports team, sports league or athlete. This creates an affinity between the contest sponsor, sports team, sports league or athlete, its charity of choice and its fans.

The contest sponsor may provide different techniques for prediction-based contests other than the “streak”-based method described above. For example, the contest sponsor may provide for a “survivor”-based contest (also known as suicide, eliminator, last man standing, or king of the hill contest) where each contest entrant pick one sports event to occur per time period, with our without taking a point spread into account. Those that predicted the event correctly advance to the next round. Contest sponsors may also choose to allow for “Mulligans” to reinstate contest entrants that were eliminated from early rounds. Alternatively, the contest could be run over a period of events with the winner of the contest being the participant that wins over a predetermined period of time.

Another type of contest may be the “confidence” system where each contest entrant pick multiple sports event to occur per time period, with our without taking a point spread into account. The contest entrant assigns a point value as to how confident he or she is with each prediction. Those that predict events beyond a predetermined threshold advance to the next round.

Another type of contest may be the tournament-based contests that may be used for popular single-elimination tournaments such as the NCAA college basketball playoffs. In this contest, contest entrants make predictions for all events that will take place in a particular tournament. The contest sponsor awards points for each correct pick and these points increase as the tournament progresses.

Seed Based Predictions with Charity Tie-in

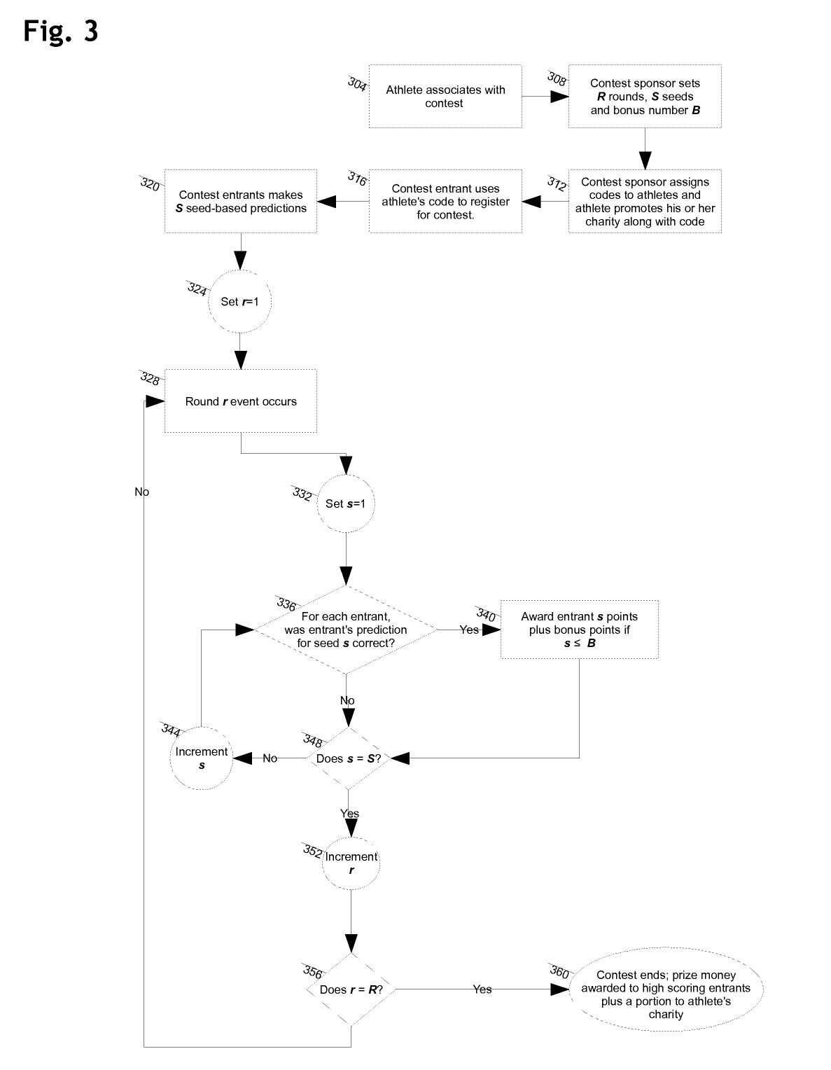

FIG. 3 demonstrates a sports-related contest involving seed-based predictions with a charity tie-in. The contest sponsor may use a unique seed-based contest suitable for multiple round single-elimination tournaments. The contest sponsor arranges for the contest entrant to associate his or her participation with one or more philanthropic organizations. These philanthropic organizations may be associated with the contest sponsor or contest entrant directly. In addition, the philanthropic organizations may be associated with (or sponsored by) the sports league, sports team and/or athletes that provide the underlying statistics for the contest. The contest sponsor may provide or make available an affinity code for contest entrants to use when entering the contest to identify the particular philanthropic organization that the contest entrant is interested in assisting. The contest sponsor may then donate part of the fee received from the contest entrant to the chosen philanthropic organization. In this way, those fans that identify with a contest sponsor, sports team, sports league or athlete may also identify with that entity's chosen philanthropic organization.

As an example, an athlete may associate with a contest sponsor engaged in a predictive seed-based contest where there are multiple entrants with the same seed within an athletic competition 304. The contest sponsor sets the rules for the contest based on R rounds and S seeds and sets a bonus number B 308. As a further example, a 64-team single elimination tournament may have 4 sets of 16 seeded entrants with 6 rounds of play to reach a winner. The contest sponsor may then determine that predictions of the top 3 seeds will be awarded bonus points. In this example, therefore, R is 6, S is 16 and B is 3.

The contest sponsor assigns the athlete a promotional code to provide to the athlete's fans when entering the contest and the athlete may then encourage fans that follow that athlete to enter a particular contest 312. The athlete may publicize a promotional code to the fans that interested participants enter when joining the contest. When the participant enters the code while joining the contest, the contest sponsor associates that participation with the particular athlete 316.

A contest entrant then makes S predictions as to which team with seed 1 through S will advance in the tournament 320. To determine the amount of points assigned to each entrant, the following algorithm is used. The round number r begins at 1 324. After each round r event 328, the seed number s for each entrant is set to 1 332. A comparison is then made to determine if the entrant correctly predicted the victory of seed s in round r 336. If the prediction was correct, the contest sponsor awards the entrant s points. Further, if the prediction was correct and s is less than or equal to the predetermined bonus number B, the contest sponsor may awards the entrant bonus points 340, which may increase as r increases. This bonus is designed to reward the entrant for higher-seed predictions and to balance the fact that the contest otherwise awards entrants higher points for lower-seed predictions. If the prediction was not correct (or the predicted team did not play in round r because it was eliminated in earlier rounds), then no points are rewarded. If the seed value is less than the total seeds S, s is incremented by 1 344 and the process repeats 336. If the seed value s equals the total seeds S 348, then r is incremented by 1 352. If the round value r is less than the total rounds R 356, then contest continues for the next round r 328. If the round value r equals the total rounds R 356, then contest ends 360.

Upon the end of the contest, the contest sponsor may distribute a portion of the fees collected from the contest entrants to the winning entrants and a portion to the charity identified by the entrants. The charity may be associated with an athlete, the contest sponsor, the contest entrant, a sports team or sports league.

Seed-Based Prediction Contests

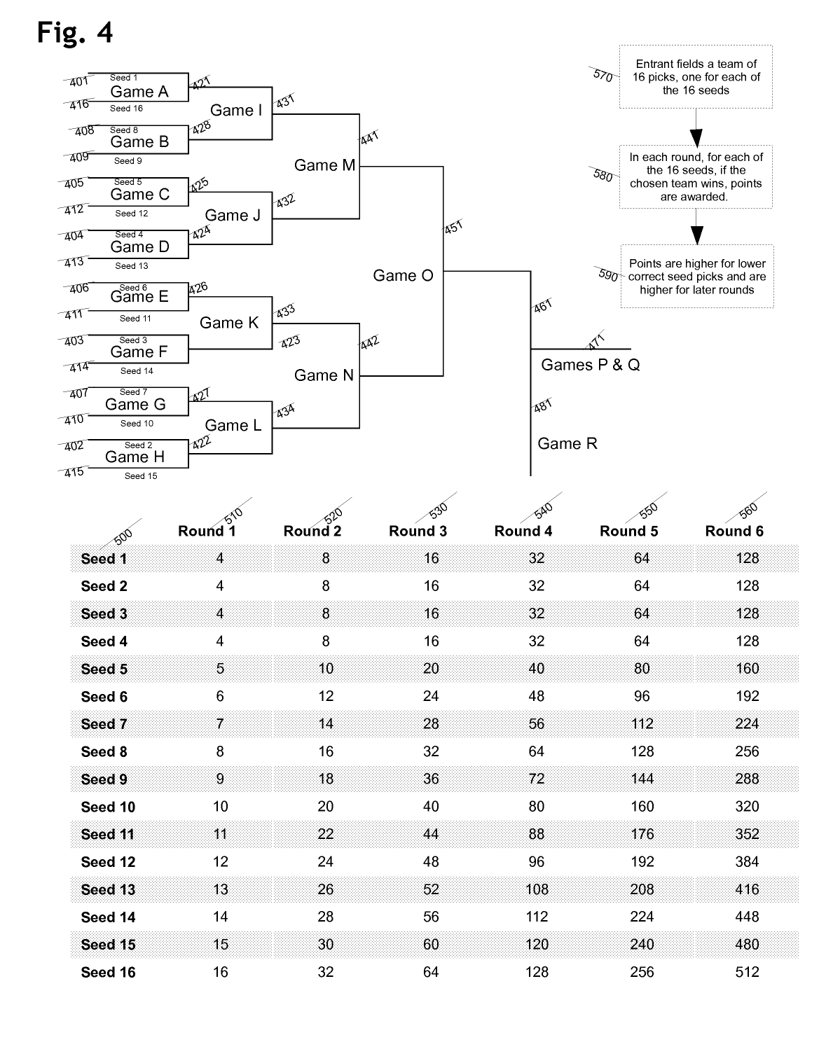

FIG. 4 demonstrates another methodology of establishing a contest related to tournament sports. Traditional pools (such as, for example, the NCAA Men's College Basketball Tournament) call for entrants to predict the winners and losers of the entire tournament before the tournament begins. This may require predictions based on games that are far into the tournament using teams that may not ever actually compete since they may have been eliminated earlier in the tournament. Usually, points are earned for successful predictions and the awarded points get larger as the rounds continue. The drawback of the traditional pool is that many participants whose picks are eliminated early in the tournament will lose interest in the later rounds when they have no more points to earn.

A single-elimination tournament may be divided into two or more groupings and arranged in such a way so that only one entrant in each group will meet at the end of the tournament to determine a winner. Within each group, the arrangement of single-elimination games may be ranked or seeded. Since there are multiple groups, this means that there are multiple entrants that will each have the same rank or seed.

For example, if there is a single-elimination tournament involving 64 teams (such as, for example, the NCAA Men's College Basketball Tournament after the “play-in” games have been completed), there may be four groups of sixteen teams. Each team in the group of 16 teams may play up to four single-elimination games in order to determine the winner of the group. In order to determine how the games are organized, the 16 teams are ranked or seeded by ability and the games within the tournament are organized accordingly.

As an example shown in FIG. 4, a contest entrant fields a team of 16 picks, one for each of the 16 seeds 570. In each of the 6 rounds of the single-elimination tournament and for each of the 16 seeds, if the chosen team wins, points are awarded to the entrant 580. The contest may be arranged such that higher points are awarded for correct lower seed picks and higher points are awarded for correct picks in later rounds 590.

As a further example in FIG. 4, for the first round in each group of 16:

the #1 seed 401 plays the #16 seed 416 (Game A 421),
the #2 seed 402 plays the #15 seed 415 (Game B 422),
the #3 seed 403 plays the #14 seed 414 (Game C 423),
the #4 seed 404 plays the #13 seed 413 (Game D 424),
the #5 seed 405 plays the #12 seed 412 (Game E 425),
the #6 seed 406 plays the #11 seed 411 (Game F 426),
the #7 seed 407 plays the #10 seed 410 (Game G 427),
the #8 seed 408 plays the #9 seed 409 (Game H 428).

The process is repeated throughout the other 3 groups in the 64-person tournament.

Thus, for each of the 16 seeds, there are 4 teams in a 64-team tournament. The entrant in the pool must choose one (and only one) of the four teams for each of the 16 seeds. As the tournament progresses, the participant is awarded points based on how far each of the chosen teams with the seed advances in the tournament. Higher point totals may be awarded as the tournament progresses and as lower-seeded teams progress throughout the tournament.

As an example, a pool entrant may be awarded points if, for each of the 16 seeds 500, the team he or she chose having that seed wins the first round. A point structure may be organized as follows 510:

| | wins the first round |
|---|---|
| | game, then the pool |
| If the chosen team from seed# . . . | entrant wins the following points: |
| 1 | 4 |
| 2 | 4 |
| 3 | 4 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |
| 14 | 14 |
| 15 | 15 |
| 16 | 16 |

Thus, in the example above, a total of 142 points may be earned. In addition, bonus points may be awarded for choosing all 16 seeded teams correctly (a streak). In addition as shown, the point totals for correct predictions may rise for teams with lower seeds rather than higher seeds.

For the second round, in each group of the remaining 8 teams of out 16:

the winner of Game A 421 plays the winner of Game H 428 (Game I 431),
the winner of Game E 425 plays the winner of Game D 424(Game J 432),
the winner of Game F 426 plays the winner of Game C 423 (Game K 433),
the winner of Game G 427 plays the winner of Game B 422 (Game L 434).

The process is repeated throughout the other 3 groups in the 64-person tournament.

As an example, a pool entrant may be awarded points if, for each of the 16 seeds, the team he or she chose having that seed wins the second round. A point structure may be organized as follows 520:

| | wins the second round game, |
|---|---|
| | then the pool entrant wins |
| If the chosen team from seed# . . . | the following points: |
| 1 | 8 |
| 2 | 8 |
| 3 | 8 |
| 4 | 8 |
| 5 | 10 |
| 6 | 12 |
| 7 | 14 |
| 8 | 16 |
| 9 | 18 |
| 10 | 20 |
| 11 | 22 |
| 12 | 24 |
| 13 | 26 |
| 14 | 28 |
| 15 | 30 |
| 16 | 32 |

For the third round, in each group of the remaining 4 teams of out 16:

the winner of Game I 431 plays the winner of Game J 432 (Game M 441),
the winner of Game K 433 plays the winner of Game L 434 (Game N 442).

The process is repeated throughout the other 3 groups in the 64-person tournament.

As an example, a pool entrant may be awarded points if, for each of the 16 seeds, the team he or she chose having that seed wins the third round. A point structure may be organized as follows 530:

| | wins the third round game, |
|---|---|
| | then the pool entrant |
| If the chosen team from seed# . . . | wins the following points: |
| 1 | 16 |
| 2 | 16 |
| 3 | 16 |
| 4 | 16 |
| 5 | 20 |
| 6 | 24 |
| 7 | 28 |
| 8 | 32 |
| 9 | 36 |
| 10 | 40 |
| 11 | 44 |
| 12 | 48 |
| 13 | 52 |
| 14 | 56 |
| 15 | 60 |
| 16 | 64 |

For the fourth round, in each group of the remaining 2 teams of out 16, the winner of Game M 441 plays the winner of Game N 442 (Game O 451).

The process is repeated throughout the other 3 groups in the 64-person tournament.

As an example, a pool entrant may be awarded points if, for each of the 16 seeds, the team he or she chose having that seed wins the fourth round. A point structure may be organized as follows 540:

| | wins the fourth round game, |
|---|---|
| | then the pool entrant wins |
| If the chosen team from seed# . . . | the following points: |
| 1 | 32 |
| 2 | 32 |
| 3 | 32 |
| 4 | 32 |
| 5 | 40 |
| 6 | 48 |
| 7 | 56 |
| 8 | 64 |
| 9 | 72 |
| 10 | 80 |
| 11 | 88 |
| 12 | 96 |
| 13 | 108 |
| 14 | 112 |
| 15 | 120 |
| 16 | 128 |

Once each group of 16 has a winner, the winners of the four groups play each other in a single elimination fifth and sixth rounds to determine a winner. The two games in the fifth round are Games P and Q 471 that are played between the winners of each of the group of 16, including the winner of Game O 451.

As an example, a pool entrant may be awarded points if, for each of the 16 seeds, the team he or she chose having that seed wins the fifth round. A point structure may be organized as follows 550:

| | wins the fifth round |
|---|---|
| | game, then the pool |
| If the chosen team from seed# . . . | entrant wins the following points: |
| 1 | 64 |
| 2 | 64 |
| 3 | 64 |
| 4 | 64 |
| 5 | 80 |
| 6 | 96 |
| 7 | 112 |
| 8 | 128 |
| 9 | 144 |
| 10 | 160 |
| 11 | 176 |
| 12 | 192 |
| 13 | 208 |
| 14 | 224 |
| 15 | 240 |
| 16 | 256 |

The sole game of the sixth round, Game R 481 is played by the winners of Games P & Q 471.

As an example, a pool entrant may be awarded points if, for each of the 16 seeds, the team he or she chose having that seed wins the sixth and final round. A point structure may be organized as follows 560:

| | wins the fifth round |
|---|---|
| | game, then the pool |
| If the chosen team from seed# . . . | entrant wins the following points: |
| 1 | 128 |
| 2 | 128 |
| 3 | 128 |
| 4 | 128 |
| 5 | 160 |
| 6 | 192 |
| 7 | 224 |
| 8 | 256 |
| 9 | 288 |
| 10 | 320 |
| 11 | 352 |
| 12 | 384 |
| 13 | 416 |
| 14 | 448 |
| 15 | 480 |
| 16 | 512 |

The point systems shown above share common traits:

1. In each particular round, the same points are awarded for correct predictions for the first 4 seeds. Higher points are awarded beginning with the 5^{th} seed and increasing until the 16^{th} and final seed.

2. For each seed, the amount of points awarded from one round to the next round doubles in value.

For each entrant, the total point values are tallied for each of the 16 seeds are tallied for an overall score. Prizes may be awarded for those who obtain the highest score.

The foregoing structure may be replicated with tournaments of varying types and varying sports. It may be used with different scoring systems that award higher points or lower points based on certain pre-defined criteria. It may be used for any sport or game or other activity where teams or persons compete against another in a series of competitions. It may be used in single-elimination tournaments, double-elimination tournaments, round-robin tournaments, Swiss-system tournaments or other arrangements.

The methods and apparatus that may be used to accomplish the above are numerous. The contests sponsors, contest entrants, philanthropic organizations, sports leagues, sports teams and athletes may use paper-based systems or electronic-based systems or a combination of the two. The paper-based systems may incorporate the use of newspapers, periodicals, newsletter, board games and the like. The electronic-based systems may incorporate the use of electronic mail, web pages, social media, mobile devices, telephonic devices, desktop devices and the like. Systems may be stand-alone devices or methods capable of operating the contests as described or devices or methods that are designed to operate the contest as described on a pre-existing platform.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. An apparatus comprising:
a contest based on the accuracy of predictions for a real-world future sports event, the contest having a sponsor, a rule set and plurality of entrants;
wherein the rule set awards points to entrants that achieves a correct prediction of a consecutive series of future sports events without an intervening incorrect prediction.

2. The apparatus as in claim 1, further comprising the sponsor using social media to promote correct predictions of a consecutive series of future sports events without an intervening incorrect prediction.

3. The apparatus as in claim 1, further comprising the rule set establishing a series of multiple overlapping sub-contests requiring the prediction of future sports events without an intervening incorrect prediction.

4. The apparatus as in claim 3, wherein the entrants that succeed in the multiple overlapping sub-contests are awarded compensation by the sponsor.

5. The apparatus as in claim 4, wherein the compensation is derived from an insurance policy obtained by the sponsor.

6. The apparatus as in claim 1, wherein the sponsor delegates the authority to determine all entrants to the contest to at least one entrant.

7. An apparatus comprising:
a contest based on a real-world football season having a plurality of real-world football rounds, the contest having a sponsor, a rule set and plurality of entrants;
wherein the rule set comprises criteria for awarding points to entrants based on correct predictions of future events within a particular football round;
wherein the rule set further comprises awarding additional points for a perfect set of correct prediction of future events within a particular football round.

8. The apparatus as in claim 7, wherein the rule set further comprises at least one set of tie-breaker rules to determine a winner if at least one of the plurality of entrants achieves the same point total.

9. The apparatus as in claim 8, wherein the awarding additional points for multiple correct predictions of future events within a particular football round involve predictions related to passing, rushing and kicking.

10. The apparatus as in claim 9, further comprising awarding compensation from the sponsor to entrants that earn the most points from all football rounds that take place within an entire regular football season.

11. The apparatus as in claim 8, wherein additional points are awarded to entrants that correctly make predictions related to at least two of passing touchdowns, rushing touchdowns and receiving touchdowns within a particular football round.

12. The apparatus as in claim 8, wherein additional points are awarded to entrants that correctly make predictions related to at least two of passing yards, rushing yards and receiving yards within a particular football round.

13. The apparatus as in claim 8, wherein additional points are awarded to entrants that correctly make predictions related to at least two of sacks, interceptions and field goals within a particular football round.

14. The apparatus as in claim 8, wherein additional points are awarded to entrants that correctly make predictions related to passing touchdowns and passing yards within a particular football round.

15. The apparatus as in claim 8, wherein additional points are awarded to entrants that correctly make predictions related to rushing touchdowns and rushing yards within a particular football round.

16. The apparatus as in claim 8, wherein additional points are awarded to entrants that correctly make predictions related to receiving touchdowns and receiving yards within a particular football round.

17. The apparatus as in claim 8, wherein the sponsor delegates the authority to determine all entrants to the contest to at least one entrant.

18. An apparatus comprising:
a contest based on a real-world football season having a plurality of real-world football rounds, the contest having a sponsor, a rule set and plurality of entrants;
wherein the rule set comprises criteria for awarding compensation to entrants that correctly predict future events related to a particular football category in all football rounds within a football season; and
wherein the rule set further comprises at least one set of tie-breaker rules to determine a winner if at least one of the plurality of entrants achieves the same point total.

19. The apparatus as in claim 18, wherein the compensation is derived from an insurance policy obtained by the sponsor.

20. The apparatus as in claim 19, wherein the football category is related to passing touchdowns, receiving touchdowns and rushing touchdowns.

21. The apparatus as in claim 19, wherein the football category is related to passing yards, receiving yards and rushing yards.

22. The apparatus as in claim 19, wherein the football category is related to sacks, field goals and interceptions.

23. The apparatus as in claim 19, wherein the sponsor delegates the authority to determine all entrants to the contest to at least one entrant.

24. An apparatus comprising:
a contest based on a single-elimination tournament having a plurality of tournament rounds and a plurality of tournament participants, the contest having a sponsor, a rule set and plurality of entrants;
wherein the schedule of the plurality of tournament participants is determined by assigning a seed value to each of the plurality of tournament participants and wherein the same seed value is assigned to more than one tournament participant;
wherein the rule set comprises a requirement that, before the beginning of the first tournament round, the entrant chooses a tournament participant for each of the seed values;
wherein, in each tournament round, the rule set comprises criteria for awarding points to each entrant based on the actual victories of the tournament participants chosen by the entrant for each of the seed values.

25. The apparatus as in claim 24, wherein the seed values comprise a plurality of seed rankings ranging from higher seed rankings to lower seed rankings;
and wherein for each tournament round, the criteria for awarding points to each entrant provide for higher point awards for correct predictions related to tournament participants with lower seed rankings and for lower point awards for correct predictions related to tournament participants with higher seed rankings.

26. The apparatus as in claim 25, wherein for each tournament round, the criteria for awarding points to each entrant provide for higher point awards for the tournament round when compared to the point awards for the previous tournament round.

27. The apparatus as in claim 26, wherein the single-elimination tournament comprises a basketball tournament having 64 tournament participants and 6 tournament rounds.

28. The apparatus as in claim 26, wherein the sponsor delegates the authority to determine all entrants to the contest to at least one entrant.

29. The apparatus as in claim 26, wherein the entrants are awarded compensation by the sponsor based on their point totals.

30. The apparatus as in claim 29, wherein the compensation is derived from an insurance policy obtained by the sponsor.
